(19) United States
(12) Patent Application Publication
(10) Pub. No.: US 2026/0326752 A1
(43) Pub. Date: Oct. 22, 2026

(54) VEHICULAR VISION SYSTEM WITH OBJECT DETECTION

(71) Applicant: Magna Electronics Inc., Auburn Hills, MI (US)

(72) Inventors: Priyank Mohan Pitrubhakta, Pune (IN); Virendra Sanjay Avhad, Mumbai (IN)

(21) Appl. No.: 19/647,116

(22) Filed: Apr. 14, 2026

Related U.S. Application Data
(60) Provisional application No. 63/790,791, filed on Apr. 18, 2025.

(51) Int. Cl. B60W 30/09; B60W 50/14

(52) U.S. Cl. CPC B60W 30/09; B60W 50/14; B60W 2050/143

(57) ABSTRACT

A vehicular sensing system includes a camera that views a first region exterior a vehicle and a sensor that senses a second region exterior the vehicle that at least partially overlaps the first region. The system, based on processing sensor data captured by the sensor, generates point map data representative of the second region. The system, based on processing image data captured by the camera, detects an object in the first region.

The system monitors a portion of the generated point map data that corresponds to the detected object. As the vehicle moves, and responsive to determining that the detected object is within a threshold distance of the vehicle, the system performs an evasive maneuver.

### CROSS REFERENCE TO RELATED APPLICATION

The present application claims the filing benefits of U.S. provisional application Ser. No. 63/790,791, filed Apr. 18, 2025, which is hereby incorporated herein by reference in its entirety.

### FIELD OF THE INVENTION

The present invention relates generally to a vehicle sensing system for a vehicle and, more particularly, to a vehicle sensing system that utilizes one or more exterior sensing sensors at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A driving assistance system or vision system or imaging system for a vehicle utilizes one or more cameras (preferably one or more CMOS cameras) to capture image data representative of regions exterior of the vehicle, and utilizes one or more sensors (e.g., ultrasonic sensors) to capture sensor data representative of regions exterior of the vehicle. The regions viewed by the cameras may at least partially overlap with the regions sensed by the ultrasonic sensors. By fusing object detection by the camera with object detection by the ultrasonic sensors, the vision system may perform object detection and more accurately track position of the objects relative to the vehicle.

For example, a vision system may include a camera disposed at a vehicle equipped with the vehicular sensing system, where the camera views a first region exterior of the vehicle and is operable to capture image data. A sensor (e.g., an ultrasonic sensor) is disposed at the vehicle and senses a second region exterior of the vehicle. The sensor is operable to capture sensor data. The first region exterior of the vehicle and the second region exterior of the vehicle at least partially overlap one another. An electronic control unit (ECU) includes electronic circuitry and associated software. The electronic circuitry of the ECU includes at least one data processor for (i) processing image data captured by the camera and transferred to the ECU and (ii) processing sensor data captured by the sensor and transferred to the ECU. The vehicular sensing system, at least in part based on processing at the ECU of sensor data captured by the sensor, generates point map data representative of the second region exterior of the vehicle. The vehicular sensing system, at least in part based on processing at the ECU of image data captured by the camera, detects an object present in the first region exterior of the vehicle. The vehicular sensing system, responsive to detecting the object in the first region exterior of the vehicle, monitors a portion of the generated point map data that corresponds to the detected object. As the vehicle moves relative to the detected object, and based on monitoring the portion of the generated point map data that corresponds to the detected object, and responsive to determining that the detected object is within a threshold distance of the vehicle, the vehicular sensing system may perform an evasive maneuver.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a perspective view of the vehicle, showing a region viewed by a forward viewing camera at the vehicle and region sensed by ultrasonic sensor at the vehicle;

FIGS. 3A-3C show the region viewed by the forward viewing camera and the region sensed by the ultrasonic sensor as the vehicle moves relative to an object;

FIG. 4 is a plan view of the vehicle showing maximum and minimum bounds of the region viewed by the forward viewing camera and the region sensed by the ultrasonic sensor;

FIG. 5 includes a table showing example maximum and minimum bounds of the region viewed by the forward viewing camera and the region sensed by the ultrasonic sensor relative to the vehicle; and

FIG. 6 shows the vehicle driving in a construction zone and a generated point map with detected objects.

### DESCRIPTION OF THE PREFERRED EMBODIMENTS

A vehicle vision system and/or sensing system and/or driver or driving assist system and/or object detection system and/or alert system operates to capture images and/or sensor data exterior of the vehicle and may process the captured image data and/or sensor data to display images and/or to detect objects at or near the vehicle and in the predicted path of the vehicle, such as to assist a driver of the vehicle in maneuvering the vehicle in a rearward direction during a parking maneuver. The vision system includes a data processor for processing captured sensor data and an image processor or image processing system that is operable to receive image data from one or more cameras and provide an output to a display device for displaying images representative of the captured image data. Optionally, the vision system may provide display, such as a rearview display or a top down or bird's eye or surround view display or the like.

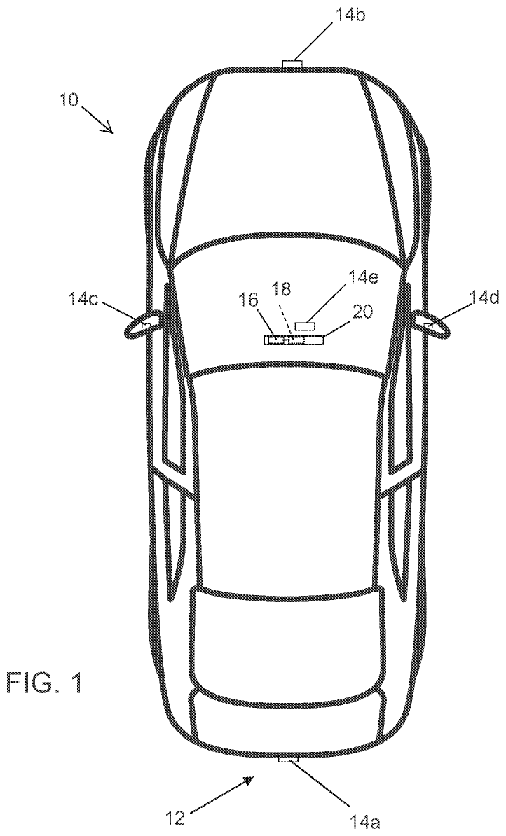

Referring now to the drawings and the illustrative embodiments depicted therein, a vehicle 10 includes a vehicular sensing system or imaging system or vision system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera 14e may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

When operating the vehicle during certain driving maneuvers or in certain environments, such as during a parking maneuver or when the vehicle is present in a garage or other confined space, a vision system may struggle to determine precise positioning of objects relative to the vehicle. For example, the objects may be detected by ultrasonic sensors that generate point map data representative of the objects and environment of the vehicle. Imprecise object detection may cause the vehicle to apply false braking or collide with the object as the precise location and type of object is not known. Determining the type of object allows the vision system to ignore point map data from curbs, speed bumps, or other items if the vehicle is in a noisy environment to avoid unnecessary false braking.

In other words, and as discussed further below, the vision system may process sensor data captured by one or more ultrasonic sensors disposed at the vehicle to detect objects present at or near the vehicle and to determine relative position of the detected objects relative to the vehicle, and the system may process image data captured by the one or more cameras at the vehicle to determine a type or classification of the detected object. Optionally, the vision system may detect the type of object via processing of the image data and then reinforce the detection via processing of the ultrasonic sensor data. Fusion of ultrasonic sensor data with image data or fusing processing of ultrasonic sensor data with processing of image data may help the vision system to envision or identify or classify the object by extracting or identifying meta data or properties of the object. This may be cost-effective as it utilizes existing sensors and cameras at the vehicle to provide precise object detection and localization.

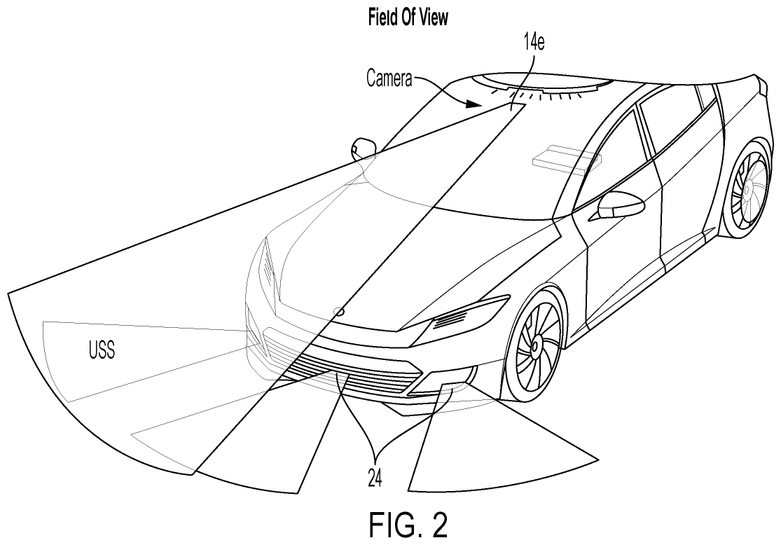

As shown in FIGS. 2-6, the forward viewing camera 14e is disposed at the windshield of the vehicle 10, such as at an upper portion of a cabin-facing side of the windshield, and views through the windshield to view a region 22 at least forward of the vehicle 10. Moreover, the vehicle 10 may include a plurality of ultrasonic sensors 24 disposed at the vehicle 10 and configured to sense respective regions 26 exterior of the vehicle 10. The system 12 may generate a point map representative of the region 26 based on processing at the ECU of sensor data captured by the ultrasonic sensor 24. In the illustrated example, the vehicle 10 includes ultrasonic sensors 24 at the forward portion of the vehicle 10, such as at the front bumper or grille or front fascia of the vehicle 10, and configured to sense at least forward and sideward of the vehicle 10. Optionally, the vehicle 10 may include ultrasonic sensors 24 disposed at side portions of the vehicle 10, such as at or near the wheel wells or wheel arches of the vehicle 10, which may be configured to sense regions exterior of the vehicle 10 and at least along the respective sides of the vehicle 10. Ultrasonic sensors 24 may further be disposed at a rear portion of the vehicle 10, such as at or near a rear bumper of the vehicle 10, and may be configured to sense a region exterior of the vehicle 10 and at least rearward of the vehicle 10.

As the vehicle 10 is moving within the environment in a forward direction of travel, such as when performing a parking maneuver or travelling within a parking garage, the system 12 may detect an object 11 near the vehicle 10 based on processing image data captured by the forward viewing camera 14e. Responsive to detecting the object 11 based on the image data, the system 12 may map and/or fuse the detected object 11 to the point map generated based on sensor data captured by the ultrasonic sensors 24. That is, the system 12 may determine a position of the detected object 11 relative to the vehicle 10 based on sensor data captured by the ultrasonic sensors 24. Additionally or alternatively, the system 12 may determine a position of the detected object 11 relative to the vehicle based on sensor data fused with image data.

After detecting the object 11, the system 12 performs object classification to determine whether the object 11 is a static or stationary or non-moving object (e.g., a stone, a pole, a curb, a speed bump, and the like) or a dynamic or moving object (e.g., a person, an animal, a moving vehicle, and the like). Object classification may be based on processing of image data to determine or recognize the type of object, and/or object classification may be based on processing of ultrasonic sensor data to determine whether the object 11 is moving relative to the vehicle 10. Identifying the object 11 helps the system 12 better understand the environment to avoid collisions or false braking. Optionally, based on determining whether the object 11 is a static object or a dynamic object, the system 12 may adjust a threshold distance at which the system 12 generates an alert to the driver, controls steering of the vehicle, and/or controls braking of the vehicle, as discussed further below. For example, the system 12 may increase the threshold distance (i.e., increase the distance at which the system 12 responds to the object 11) responsive to determining that the object 11 is dynamic, and the system 12 may decrease the threshold distance (i.e., decrease the distance at which the system 12 responds to the object 11) responsive to determining that the object 11 is static.

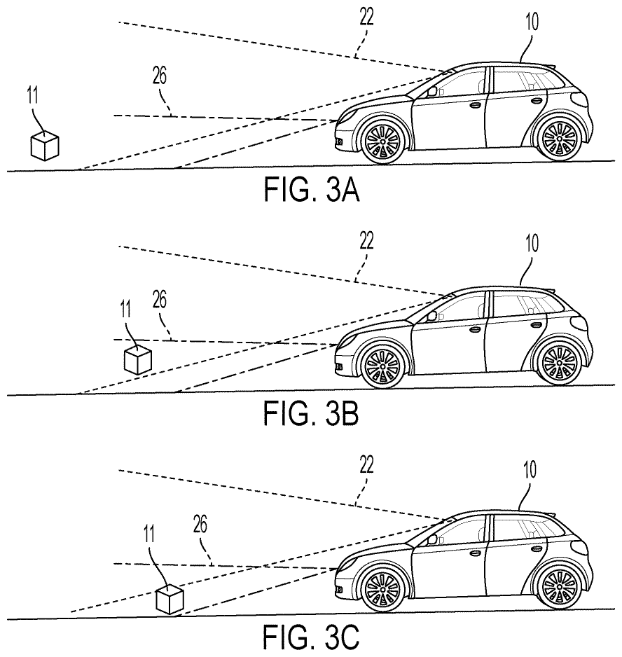

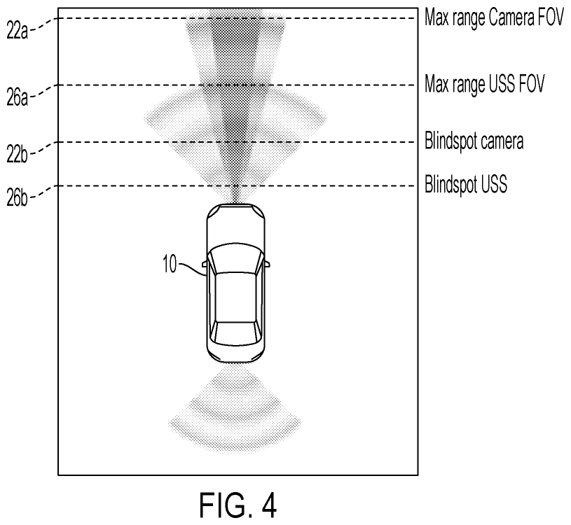

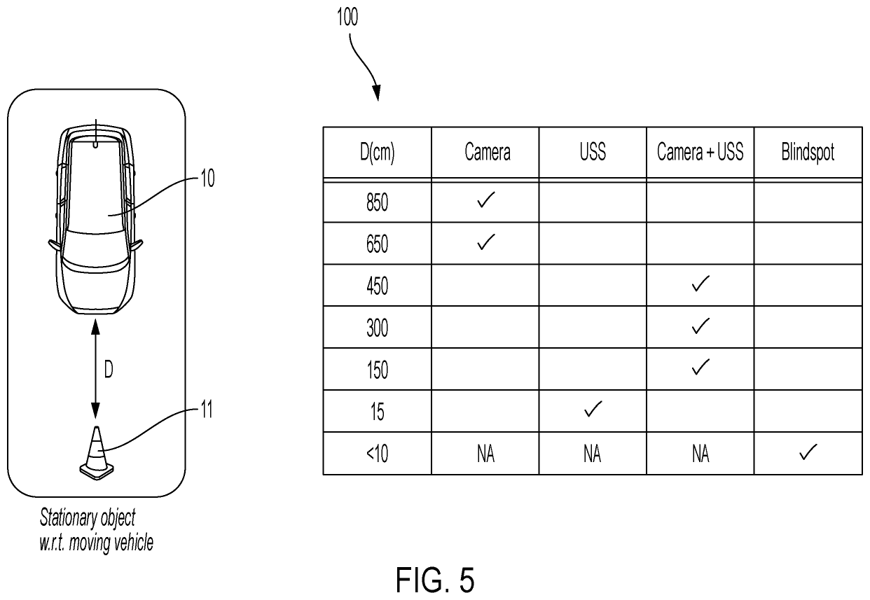

Moreover, because the vision system 12 relies on both image data and ultrasonic sensor data to detect and track objects relative to the vehicle 10, the system 12 may be able to track detected objects through a larger range of sensing. For example, and as shown in FIGS. 3A-5, the region 22 viewed by the camera 14e may extend a further distance from the vehicle 10 than the region 26 sensed by the ultrasonic sensor 24, and the region 26 sensed by the ultrasonic sensor 24 may include an area that is closer to the vehicle 10 than the region 22 viewed by the camera 14e. In other words, based on processing of image data captured by the camera 14e, the vision system 12 may be able to view objects present within the region 22 between a maximum camera sensing range distance 22a from the vehicle 10 and a minimum camera sensing range distance 22b from the vehicle 10 (FIG. 4). Based on processing of sensor data captured by the ultrasonic sensors 24, the vision system 12 may be able to sense objects 11 present within the region 26 between a maximum ultrasonic sensing range distance 26a from the vehicle 10 and a minimum ultrasonic sensing range distance 26b from the vehicle 10. The maximum camera sensing range distance 22a may be further from the vehicle 10 than the maximum ultrasonic sensing range distance 26a, and the minimum ultrasonic sensing range distance 26b may be closer to the vehicle 10 than the minimum camera sensing range distance 22b. For example, and as provided in chart 100, the ultrasonic sensors 24 may be configured to detect objects 11 within a range of about 0.15 meters or less to about 4.5 meters from the vehicle 10, and the camera 14e may be configured to view objects within a range of about 1.5 meters to about 8.5 meters or more from the vehicle 10 (FIG. 5). Based on the combined sensing ranges 22a, 22b, 26a, 26b of the camera 14e and the ultrasonic sensor 24, the vision system 12 may be able to sense an object 11 at a distance D from the vehicle 10, where the distance D is within the range of about 0.15 meters or less to about 8.5 meters or more.

Thus, as the vehicle 10 is approaching an object 11 in the environment, the system 12 may initially detect the object 11 via processing of image data captured by the camera 14e as the object 11 moves into the region 22 viewed by the camera 14e and before the object 11 moves into the region 26 sensed by the ultrasonic sensors 24 (FIG. 3A). As the object 11 moves closer to the vehicle 10 or the vehicle 10 moves closer to the object 11, the object 11 may be present in both the region 26 sensed by the ultrasonic sensors 24 and the region 22 viewed by the camera 14e (FIG. 3B). Here, the detected object 11 may be mapped to the point map generated using the ultrasonic sensors 24. As the object 11 moves even closer to the vehicle 10 or the vehicle 10 moves even closer to the object 11, the object 11 moves out of the region 22 viewed by the camera 14e and may only be present in the region 26 sensed by the ultrasonic sensors 24 (FIG. 3C). Thus, with the object 11 detected and classified via processing of the image data and the ultrasonic sensor data, the system 12 may more accurately track the object 11 in the ultrasonic point map data after the object 11 has moved out of the field of view of the camera 14e. Put another way, the detected object 11 may be more easily identified and distinguished from noise or environmental features (e.g., curbs or speed bumps) also represented in the point map data.

The system 12 may also extrapolate and/or approximate the position of an object 11 as the vehicle 10 moves from a position where the object 11 is within at least one of the viewing or sensing regions 22, 26 to a position where the object 11 is within neither region 22, 26. For example, based on detecting a stationary object 11, and based on the vehicle 10 moving close enough to the stationary object 11 that the stationary object 11 is between the vehicle 10 and the minimum ultrasonic sensing range distance 26b, the system 12 may approximate the position of the object 11 relative to the vehicle 10 as the vehicle 10 continues to move closer to the object 11. By classifying the object 11 as stationary, the system 12 may more precisely track the approximated position and provide more accurate timing for alerts to the driver and/or braking control for the vehicle 10.

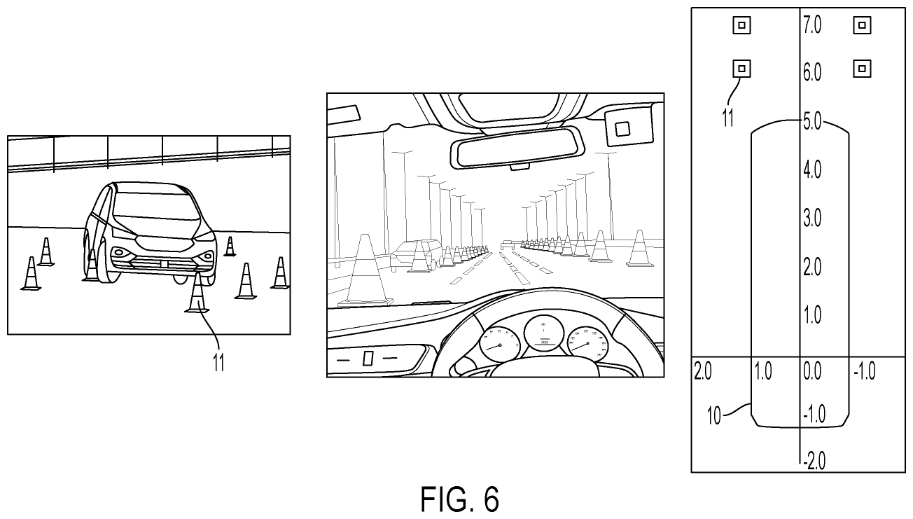

In the illustrated example of FIG. 6, as the vehicle 10 travels within a construction zone, the system 12 may detect objects 11 and classify the objects 11 as cones or pylons via processing of captured image data. Classifying the detected objects 11 as stationary cones may assist in tracking the objects 11 in the ultrasonic point map as the vehicle 10 moves relative to the objects 11.

Optionally, the system 12 may ignore objects or portions of the ultrasonic point map based on object detection. For example, based on detecting a speed bump in the path of travel of the vehicle 10, the system 12 may not issue an alert or actuate emergency braking systems as the vehicle 10 approaches and passes over the speed bump. Optionally, the system 12 suppresses and/or reduces severity of an alert or an emergency braking input responsive to the speed bump. For example, in response to determining presence of a speed bump, the system 12 may initiate automatic braking that slows the vehicle as the vehicle approaches and passes the speed bump instead of initiating automatic braking to stop the vehicle before reaching the speed bump.

Thus, in response to detecting objects present in the region 22 viewed by the camera 14e and/or present in the region 26 sensed by the ultrasonic sensors 24, the system 12 may perform object identification or classification to determine characteristics of the detected objects 11. This may result in the system 12 classifying at least some detected objects 11 as potential obstacles for the vehicle 10 and ignoring noise and other detected objects 11. The system 12 may thus better track the relative position of potential obstacles as the vehicle 10 maneuvers near them. In response to determining that the obstacle is within a threshold distance of the vehicle 10 (e.g., the obstacle is within 3 meters or less from the vehicle 10, the obstacle is within 1 meter or less from the vehicle 10, the obstacle is within 0.5 meters or less from the vehicle 10, and the like), the system 12 may generate an alert to the driver, such as by playing an audio tone within the interior cabin of the vehicle 10 or displaying an alert at a head up display of the vehicle 10 or providing a haptic alert to the driver of the vehicle 10 such as by vibrating the driver seat of the vehicle 10 or the steering wheel of the vehicle 10. Optionally, the system 12 may at least in part control steering of the vehicle 10 to avoid the obstacle or mitigate a collision with the obstacle. Further, the system 12 may at least in part control braking of the vehicle 10 to slow or stop the vehicle 10.

Although discussed herein as processing image data captured by the forward viewing camera 14e and sensor data captured by the ultrasonic sensors 24 to detect objects 11 present in a forward path of travel of the vehicle 10, the system 12 may process sensor data captured by ultrasonic sensors 24 at the rear portion of the vehicle 10 and image data captured by the rearward viewing camera 14a (such as a rear backup camera or a rearward viewing camera mounted at a rear window or center high mounted stop lamp of the vehicle 10) to detect objects 11 present in a rearward path of travel of the vehicle 10, such as when the vehicle 10 is performing a reversing maneuver. Moreover, the system 12 may process image data captured by any camera at the vehicle 10 and/or other sensors at the vehicle 10 to provide more accurate object detection in any direction relative to the vehicle 10.

This solution may be used while tunneling into the garage, as the system 12 may utilize the available space in the garage with extra caution for objects 11. For example, the system 12 may map objects 11 in the garage based on the image data captured by a forward viewing camera 14b, 14e or rearward viewing camera 14a to point map data generated based on sensor data captured by ultrasonic sensors 24. The system 12 may classify the objects 11 in the garage based on the image data and track the classified objects 11 based on the sensor data as one or more of the objects 11 moves out of the region 22 viewed by the camera 14e and is present in the region 26 sensed by the ultrasonic sensors 24, such that the objects 11 may be more accurately tracked in the ultrasonic point map data. The system 12 may also approximate the position of one or more of the objects 11 relative to the vehicle 10 as the vehicle 10 continues to move closer to the objects 11. By mapping and classifying the objects 11 in the garage, the system 12 improves accuracy in determining and utilizing available space in the garage while avoiding the objects 11. Further, during parking maneuvers, the system 12 may obtain more accurate data to park between adjacent vehicles without false braking from the equipped vehicle 10. Moreover, the system 12 may avoid engaging the brakes during curb detection or responsive to detecting speed bumps.

Fusion of the captured image data and the captured sensor data and/or processing of the image data and sensor data in a cooperative manner may utilize characteristics of the systems described in U.S. Pat. Nos. 9,495,876; 9,126,525 and/or 9,036,026, which are hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. No. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Optionally, the camera may comprise a forward viewing camera, such as disposed at a windshield electronics module (WEM) or the like. The forward viewing camera may utilize aspects of the systems described in U.S. Pat. Nos. 12,174,448; 11,635,672; 11,124,130; 9,896,039; 9,871,971; 9,596,387; 9,487,159; 8,256,821; 7,480,149; 6,824,281 and/or 6,690,268, which are all hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The system may utilize aspects of the parking assist systems described in U.S. Pat. No. 8,874,317 and/or U.S. Publication Nos. US-2017-0329346; US-2017-0317748; US-2017-0253237; US-2017-0050672; US-2017-0017848; US-2017-0015312 and/or US-2015-0344028, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular sensing system, the vehicular sensing system comprising:
a camera disposed at a vehicle equipped with the vehicular sensing system, wherein the camera views a first region exterior of the vehicle, and wherein the camera is operable to capture image data;
wherein the camera comprises an imager, and wherein the imager comprises a CMOS imaging array having at least one million photosensors arranged in rows and columns;
a sensor disposed at the vehicle and sensing a second region exterior of the vehicle, wherein the sensor is operable to capture sensor data;
wherein the first region exterior of the vehicle and the second region exterior of the vehicle at least partially overlap one another;
an electronic control unit (ECU);
wherein the ECU comprises electronic circuitry and associated software;
wherein the electronic circuitry of the ECU comprises at least one data processor for (i) processing image data captured by the camera and transferred to the ECU and (ii) processing sensor data captured by the sensor and transferred to the ECU;
wherein the vehicular sensing system, at least in part based on processing at the ECU of sensor data captured by the sensor, generates point map data representative of the second region exterior of the vehicle;
wherein the vehicular sensing system, at least in part based on processing at the ECU of image data captured by the camera, detects an object present in the first region exterior of the vehicle;
wherein the vehicular sensing system, responsive to detecting the object in the first region exterior of the vehicle, monitors a portion of the generated point map data that corresponds to the detected object; and
wherein, as the vehicle moves relative to the detected object, and based on monitoring the portion of the generated point map data that corresponds to the detected object, and responsive to determining that the detected object is within a threshold distance of the vehicle, the vehicular sensing system performs an evasive maneuver.

2. The vehicular sensing system of claim 1, wherein the sensor comprises an ultrasonic sensor.

3. The vehicular sensing system of claim 1, wherein the camera comprises a forward viewing camera, and wherein the first region is at least forward of the vehicle.

4. The vehicular sensing system of claim 3, wherein the forward viewing camera is disposed at a windshield of the vehicle and views forward of the vehicle through the windshield of the vehicle.

5. The vehicular sensing system of claim 1, wherein the vehicular sensing system, at least in part based on processing at the ECU of image data captured by the camera, determines that the detected object comprises a stationary object.

6. The vehicular sensing system of claim 5, wherein the vehicular sensing system, responsive to determining that the detected stationary object comprises a speed bump, does not perform the evasive maneuver.

7. The vehicular sensing system of claim 1, wherein the vehicular sensing system, at least in part based on processing at the ECU of image data captured by the camera, determines that the detected object comprises a dynamic object.

8. The vehicular sensing system of claim 1, wherein the vehicular sensing system, at least in part based on processing at the ECU of sensor data captured by the sensor, determines that the detected object comprises a stationary object.

9. The vehicular sensing system of claim 8, wherein the vehicular sensing system, responsive to determining that the detected stationary object comprises a speed bump, does not perform the evasive maneuver.

10. The vehicular sensing system of claim 1, wherein the vehicular sensing system, at least in part based on processing at the ECU of sensor data captured by the sensor, determines that the detected object comprises a dynamic object.

11. The vehicular sensing system of claim 1, wherein the first region extends between a first distance from the vehicle and a second distance from the vehicle, and wherein the second region extends between a third distance from the vehicle and a fourth distance from the vehicle, and wherein (i) the first distance from the vehicle is greater than the third distance from the vehicle, (ii) the fourth distance from the vehicle is greater than the first distance from the vehicle and (iii) the second distance from the vehicle is greater than fourth distance from the vehicle.

12. The vehicular sensing system of claim 1, wherein the evasive maneuver comprises at least one selected from the group consisting of (i) generating an alert to a driver of the vehicle, (ii) at least in part controlling steering of the vehicle to mitigate collision with the detected object and (iii) at least in part controlling braking of the vehicle to mitigate collision with the detected object.

13. A vehicular sensing system, the vehicular sensing system comprising:
a camera disposed at a vehicle equipped with the vehicular sensing system, wherein the camera views a first region exterior of the vehicle, and wherein the camera is operable to capture image data;
wherein the camera comprises an imager, and wherein the imager comprises a CMOS imaging array having at least one million photosensors arranged in rows and columns;
an ultrasonic sensor disposed at the vehicle and sensing a second region exterior of the vehicle, wherein the ultrasonic sensor is operable to capture sensor data;
wherein the first region exterior of the vehicle and the second region exterior of the vehicle at least partially overlap one another;
wherein the first region extends between a first distance from the vehicle and a second distance from the vehicle, and wherein the second region extends between a third distance from the vehicle and a fourth distance from the vehicle, and wherein (i) the first distance from the vehicle is greater than the third distance from the vehicle, (ii) the fourth distance from the vehicle is greater than the first distance from the vehicle and (iii) the second distance from the vehicle is greater than fourth distance from the vehicle;
an electronic control unit (ECU);
wherein the ECU comprises electronic circuitry and associated software;
wherein the electronic circuitry of the ECU comprises at least one data processor for (i) processing image data captured by the camera and transferred to the ECU and (ii) processing sensor data captured by the ultrasonic sensor and transferred to the ECU;
wherein the vehicular sensing system, at least in part based on processing at the ECU of sensor data captured by the ultrasonic sensor, generates point map data representative of the second region exterior of the vehicle;
wherein the vehicular sensing system, at least in part based on processing at the ECU of image data captured by the camera, detects an object present in the first region exterior of the vehicle;
wherein the vehicular sensing system, responsive to detecting the object in the first region exterior of the vehicle, monitors a portion of the generated point map data that corresponds to the detected object; and
wherein, as the vehicle moves relative to the detected object, and based on monitoring the portion of the generated point map data that corresponds to the detected object, and responsive to determining that the detected object is within a threshold distance of the vehicle, the vehicular sensing system performs an evasive maneuver.

14. The vehicular sensing system of claim 13, wherein the vehicular sensing system, at least in part based on processing at the ECU of image data captured by the camera, determines that the detected object comprises a stationary object.

15. The vehicular sensing system of claim 14, wherein the vehicular sensing system, responsive to determining that the detected stationary object comprises a speed bump, does not perform the evasive maneuver.

16. The vehicular sensing system of claim 13, wherein the vehicular sensing system, at least in part based on processing at the ECU of sensor data captured by the ultrasonic sensor, determines that the detected object comprises a stationary object.

17. The vehicular sensing system of claim 16, wherein the vehicular sensing system, responsive to determining that the detected stationary object comprises a speed bump, does not perform the evasive maneuver.

18. The vehicular sensing system of claim 13, wherein the evasive maneuver comprises at least one selected from the group consisting of (i) generating an alert to a driver of the vehicle, (ii) at least in part controlling steering of the vehicle to mitigate collision with the detected object and (iii) at least in part controlling braking of the vehicle to mitigate collision with the detected object.

19. A vehicular sensing system, the vehicular sensing system comprising:
a forward viewing camera disposed at a vehicle equipped with the vehicular sensing system, wherein the forward viewing camera views a first region exterior at least forward of the vehicle, and wherein the forward viewing camera is operable to capture image data;
wherein the forward viewing camera is disposed at a windshield of the vehicle and views forward of the vehicle through the windshield of the vehicle;
wherein the forward viewing camera comprises an imager, and wherein the imager comprises a CMOS imaging array having at least one million photosensors arranged in rows and columns;
a sensor disposed at the vehicle and sensing a second region exterior of the vehicle, wherein the sensor is operable to capture sensor data;
wherein the first region exterior of the vehicle and the second region exterior of the vehicle at least partially overlap one another;
an electronic control unit (ECU);
wherein the ECU comprises electronic circuitry and associated software;
wherein the electronic circuitry of the ECU comprises at least one data processor for (i) processing image data captured by the forward viewing camera and transferred to the ECU and (ii) processing sensor data captured by the sensor and transferred to the ECU;
wherein the vehicular sensing system, at least in part based on processing at the ECU of sensor data captured by the sensor, generates point map data representative of the second region exterior of the vehicle;
wherein the vehicular sensing system, at least in part based on processing at the ECU of image data captured by the forward viewing camera, detects an object present in the first region exterior of the vehicle;
wherein the vehicular sensing system, at least in part based on processing at the ECU of image data captured by the forward viewing camera and processing at the ECU of sensor data captured by the sensor, determines that the detected object comprises a dynamic object;
wherein the vehicular sensing system, responsive to determining that the detected object comprises a dynamic object, and responsive to detecting the dynamic object in the first region exterior of the vehicle, monitors a portion of the generated point map data that corresponds to the detected dynamic object; and
wherein, as the vehicle moves relative to the detected dynamic object, and based on monitoring the portion of the generated point map data that corresponds to the detected dynamic object, and responsive to determining that the detected dynamic object is within a threshold distance of the vehicle, the vehicular sensing system performs an evasive maneuver.

20. The vehicular sensing system of claim 19, wherein the evasive maneuver comprises at least one selected from the group consisting of (i) generating an alert to a driver of the vehicle, (ii) at least in part controlling steering of the vehicle to mitigate collision with the detected dynamic object and (iii) at least in part controlling braking of the vehicle to mitigate collision with the detected dynamic object.
